(19) United States
(12) Patent Application Publication
(10) Pub. No.: US 2011/0019126 A1
(43) Pub. Date: Jan. 27, 2011

(54) APPARATUS FOR RADIATING HEAT OF LIGHT EMITTING DIODE AND LIQUID CRYSTAL DISPLAY USING THE SAME

(76) Inventors: Byungjin Choi, Gumi-si (KR); Hongsung Song, Gumi-si (KR); Ohhyun Lee, Gimchon-si (KR)

Correspondence Address: BRINKS HOFER GILSON & LIONE, P.O. BOX 10395, CHICAGO, IL, 60610, US

(21) Appl. No.: 12/622,100

(22) Filed: Nov. 19, 2009

(30) Foreign Application Priority Data
Jul. 24, 2009 (KR) 10-2009-067999

(51) Int. Cl. G02F 1/1335; F21S 4/00

(52) U.S. Cl. 349/61; 362/249.02

(57) ABSTRACT

Provided is an apparatus for radiating heat of a light emitting diode (LED), which includes a plurality of LED packages respectively including a LED chip and a heat-radiating metal plate; and a printed circuit board (PCB) including a top face with which the heat-radiating plate of the LED package is contacted, circuit patterns and solder resist are formed, a bottom face on which a metal layer is formed, a hole penetrating the top face and the bottom, a metal sidewall formed on the sidewall of the hole to connect the heat-radiating plate of the LED package and the metal layer, and a cavity formed in the holes.

This application claims the benefit of Korea Patent Application No. 10-2009-067999, filed on Jul. 24, 2009, the entire contents of which is incorporated herein by reference for all purposes as if fully set forth herein.

### BACKGROUND

1. Field of the Invention

This disclosure relates to an apparatus for radiating heat of a light emitting diode (LED) and a liquid crystal display using the same.

2. Discussion of the Related Art

A LED is a diode having two terminals, which is formed of a compound semiconductor material such as GaAs, AlGaAs, GaN, InGaN or AlGaInP. The LED emits a visible ray using optical energy generated when electrons and holes are combined according to power applied to a cathode and an anode.

A white LED emitting white light is implemented by a combination of red, green and blue LEDs or a combination of a blue LED and yellow phosphor. With the advent of the white LED, LEDs have been applied to a wide range of applications ranging from an indicator of electronic product to household goods and advertisement panels. Recently, LEDs have been used as substitutes for lights in streetlights, head lamps of vehicles, normal illuminating lights for replacing fluorescent lamps because of the high efficiency of LED chips. The LEDs have high-power and high-luminance and the efficiency thereof surpasses the existing glow lamp and is similar to or superior to the efficiency of the existing fluorescent lamp.

Approximately 15% of energy applied to an LED package is converted into light and approximately 85% of the energy is consumed as heat. The efficiency and lifetime of the LED package decrease as heat generated from a PN junction of an LED increases. Accordingly, an LED package with high power and high luminance requires a design for radiating heat generated from an LED chip.

The LED package is usually soldered onto an expensive metal printed circuit board (PCB) or a thermal clad board for heat radiation. The metal PCB has a stacked structure of an aluminum substrate, a resin layer, a copper foil layer and a solder resist layer which are sequentially laminated. The resin layer electrically insulates the copper foil layer flowing current and the aluminum substrate from each other and forms a heat transfer path between the copper foil layer and the aluminum substrate. Heat generated from the LED package is transferred through the copper foil layer and then transmitted to the aluminum substrate through the resin layer. Accordingly, the thermal conductivity of the resin layer must be increased in order to achieve an efficient heat-radiating structure. The thermal conductivity of the resin layer used for the metal PCB is approximately 1.0 to 2.2 W/mk. The metal PCB requires, combining of aluminum and copper foil opposite to each other so that the resin layer is formed between them, reliably bonding of the two metals having different thermal expansion coefficients, and reducing stress between the two metals generated during thermal expansion. The thermal expansion coefficient of copper is approximately 17 ppm/K and the thermal expansion coefficient of aluminum is approximately 25 ppm/K. To satisfy the performance required by the resin layer of the metal PCB, the resin layer used for the metal PCB has a thickness in the range of 0.075 to 0.30 mm. Due to this relatively thick resin layer, heat does not smoothly flow between the copper layer and the metal substrate in the metal PCB. Heat transfer in the metal PCB will be explained in detail. Heat generated from the LED chip is radiated through the package body, the solder layer, the copper foil layer, the resin layer and the aluminum substrate. The resin layer brings about bottle neck phenomenon of heat radiation in heat flow due to low thermal conductivity of the resin layer. If a plurality of LED packages are mounted on the metal PCB in an array form, an additional heat sink may be attached to the bottom face of the metal PCB to radiate heat because low heat-radiating effect is obtained only by the metal PCB. In this case, thermal grease may be dispensed between the metal PCB and the heat sink in order to remove an air layer between the metal PCB and the heat sink. However, the thermal grease obstructs flow of heat because the thermal conductivity of the thermal grease is as low as about 2 to 3 W/mK.

LED chips may be directly mounted on a PCB or a flexible printed circuit (FPC) through surface mount technology (SMT) according to miniaturization of display devices and information communication devices. In a backlight unit of a liquid crystal display, LED chips are mounted on an FPC and a metal plate or a metal heat sink may be attached to the FPC to radiate heat without using an expensive metal PCB. However, this heat-radiating plan also requires an expensive metal plate and FPC to increase the cost and does not provide sufficient heat-radiating effect.

### BRIEF SUMMARY

An apparatus for radiating heat of a light emitting diode (LED) includes a plurality of LED packages respectively including a LED chip and a heat-radiating metal plate; and a printed circuit board (PCB) including a top face with which the heat-radiating plate of the LED package is contacted, circuit patterns and solder resist are formed, a bottom face on which a metal layer is formed, a hole penetrating the top face and the bottom, a metal sidewall formed on the sidewall of the hole to connect the heat-radiating plate of the LED package and the metal layer, and a cavity formed in the hole.

According to another aspect of this disclosure, a liquid crystal display includes a liquid crystal display panel; and a backlight unit that illuminates the liquid crystal display panel.

The backlight unit includes a plurality of LED packages respectively including a LED chip and a heat-radiating metal plate; and a printed circuit board (PCB) including a top face with which the heat-radiating plate of the LED package is contacted, circuit patterns and solder resist are formed, a bottom face on which a metal layer is formed, a hole penetrating the top face and the bottom, a metal sidewall formed on the sidewall of the hole to connect the heat-radiating plate of the LED package and the metal layer, and a cavity formed in the hole.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross-sectional view of an apparatus for radiating heat of an LED according to a first embodiment of this disclosure;

FIGS. 2 and 3 are plan view showing the bottom face of an LED package illustrated in FIG. 1;

FIG. 4 is a cross-sectional view of an apparatus for radiating heat of an LED according to a second embodiment of this disclosure;

FIG. 5 is a cross-sectional view of the apparatus for radiating heat of an LED illustrated in FIG. 4;

FIG. 6 is a cross-sectional view of an apparatus for radiating heat of an LED according to a third embodiment of this disclosure;

FIG. 7 is a cross-sectional view of a liquid crystal display according to a first embodiment of this disclosure; and

FIG. 8 is a cross-sectional view of a liquid crystal display according to a second embodiment of this disclosure.

### DETAILED DESCRIPTION OF THE DRAWINGS AND THE PRESENTLY PREFERRED EMBODIMENTS

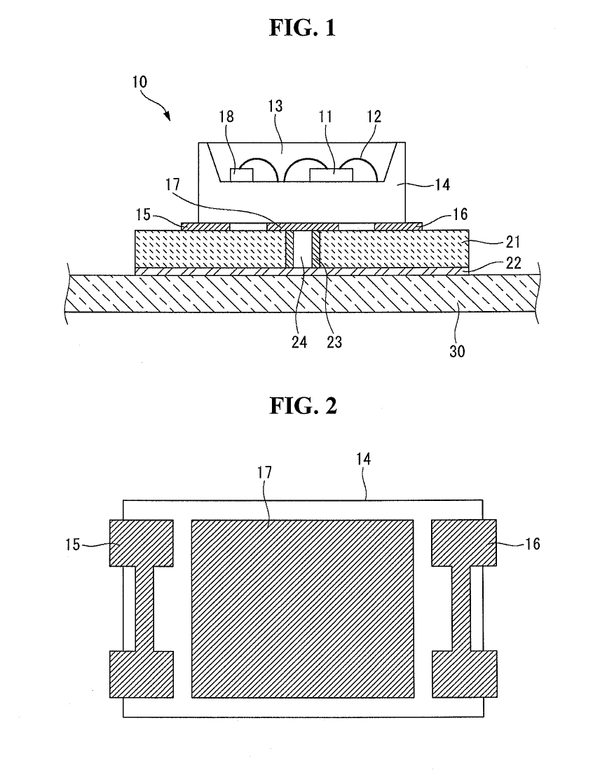

Embodiments of the invention will be explained in detail with reference to FIGS. 1 through 8.

FIG. 1 is a cross-sectional view of an apparatus for radiating heat of an LED according to a first embodiment of this disclosure.

Referring to FIG. 1, an LED package 10 according to the invention is mounted on a PCB 21.

The LED package 10 includes a package body 14, a zener diode 18, at least one LED chip 11, a cathode lead frame 15, an anode lead frame 16, and a heat-radiating metal plate 17. The zener diode 18 and the LED chip 11 are mounted on a recess formed on the surface of the package body 14. A cathode of the LED chip 11 is connected to the cathode lead frame 15 through a wire 12 and an anode of the LED chip 11 is connected to the anode lead frame 16 through the wire 12. The zener diode 18 is connected to the LED chip 11 through a wire and blocks static electricity flowing to the LED chip 11 to protect the LED chip 11 from the static electricity.

The cathode lead frame 15, the anode lead frame 16 and the heat-radiating metal plate 17 are formed as metal patterns separated from one another on the bottom face of the package body 14. The cathode lead frame 15, the anode lead frame 16 and the heat-radiating metal plate 17 is formed of the same metal.

A resin 13 is filled in the recess formed on the surface of the LED package 10. The resin 13 transmits a visible ray generated from the LED chip 11 and protects the LED chip 11, the zener diode 18 and the wire 12 from moisture and oxygen. The resin 13 may include a fluorescent material.

A flame retardant composition 4 (FR4) PCB may be selected as the PCB 21. Circuit patterns for supplying power to the LED package are formed on the top face of the PCB 21 and a solder resist is coated thereon. A metal layer 22 such as copper foil is formed in a wide area on the bottom face of the PCB 21 and the solder resist is not coated on the bottom face of the PCB 21. The PCB 21 includes a hole. A metal sidewall 23 is formed on the sidewall of the hole formed in the PCB 21 and a cavity 24 including air is formed in the hole. Here, the hole may be a via-hole or a through-hole. The sidewall of the hole is plated with copper to form the metal sidewall 23 when the hole is a via-hole. The sidewall of the hole is plated with copper and the copper layer is plated with gold to form the metal sidewall 23 when the hole is a through-hole. The metal sidewall 23 penetrates the top and bottom faces of the PCB 21 to connect the heat-radiating metal plate 17 of the LED package 10 to the metal layer 22 formed on the bottom face of the PCB 21 so as to form a heat-radiating path of the LED package 10. If the hole of the PCB 21 is fully charged with a metal, the metal is thermally expanded in the sealed hole at a solder temperature of SMT equipment and overflow the hole to cause short-circuiting of circuit patterns and poor mounting of the LED package 10. Accordingly, the metal sidewall 23 must be formed only on the sidewall of the hole such that the hole is not fully charged with the metal and the cavity 24 exists in the hole. A connector (not shown) may be mounted on the top face of the PCB 21. The connector mounted on the PCB 21 is connected to a connector of the PCB on which an LED driving circuit is mounted through an FPC or a flexible flat cable (FFC) to provide power from the LED driving circuit to the LED package 10 through the circuit patterns.

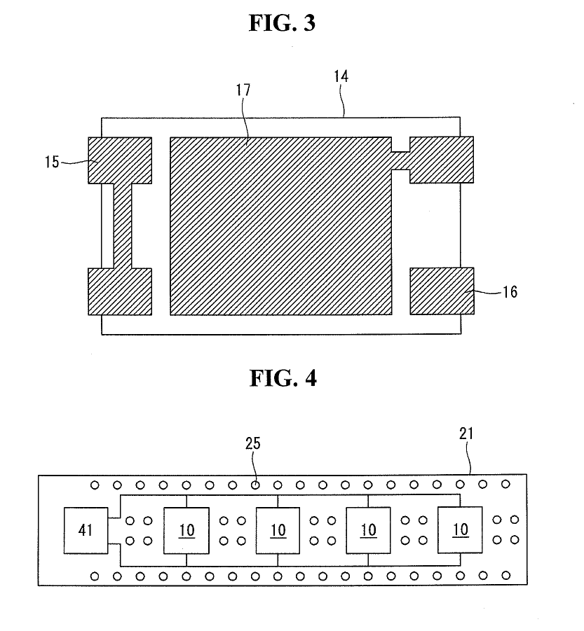

FIGS. 2 and 3 are plan view showing the bottom face of then LED package 10 illustrated in FIG. 1.

Referring to FIGS. 2 and 3, the cathode lead frame 15 and the anode lead frame 16 are separated from each other and arranged on both sides of the package body 14. The heat-radiating metal plate 17 is formed in a wide area at the center of the bottom face of the package body 14 and separated from the cathode lead frame 15 and the anode lead frame 16, as illustrated in FIG. 2. Furthermore, the heat-radiating metal plate 17 may include a metal plate connected to a metal pattern separated from the cathode lead frame 15 or the anode lead frame 16 to increase the area thereof, as illustrated in FIG. 3. In the case of FIG. 3, the cathode lead frame 15 and the anode lead frame 16 have different areas.

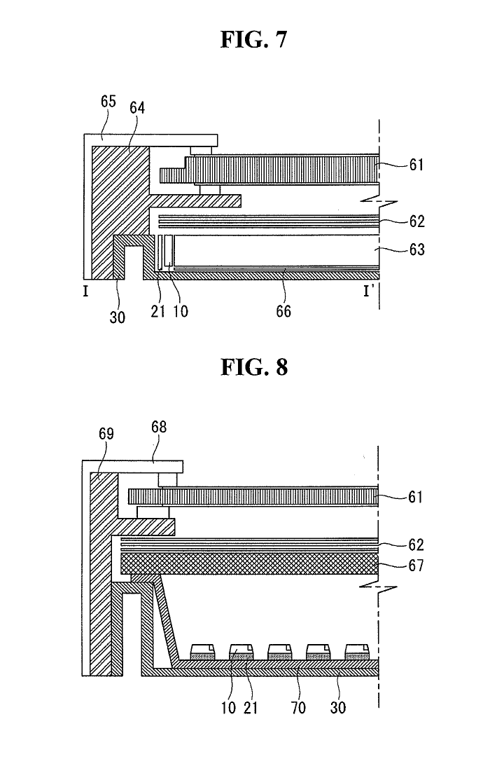

The PCB 21 is attached to a cover bottom 30 in such a manner that the metal layer 22 formed on the bottom face of the PCB 21 faces the cover bottom 30. The cover bottom 30 is formed of aluminum or aluminum alloy and corresponds to a case member applied to a backlight unit of a liquid crystal display, as illustrated in FIGS. 7 and 8. The PCB 21 is attached to the cover bottom 30 through a known heat-radiating pad. In addition, the PCB 21 is attached to the cover bottom 30 through various bonding methods using welding, an adhesive, a screw, a hook, etc. There is no need to form an additional heat sink between the PCB 21 and the cover bottom 30.

The cover bottom 30 is grounded. In this case, the metal layer 22 formed on the bottom face of the PCB 21 attached to the cover bottom 30 may form a ground plane.

Heat generated from the LED package 10 is radiated through the heat-radiating metal plate 17 formed on the bottom face of the LED package 10, the metal sidewall 23 formed on the sidewall of the hole of the PCB 21, the metal layer 22 formed on the bottom face of the PCB 21 and the cover bottom 30. Accordingly, the heat generated from the Led package 10 is radiated along a heat-radiating path formed of metal.

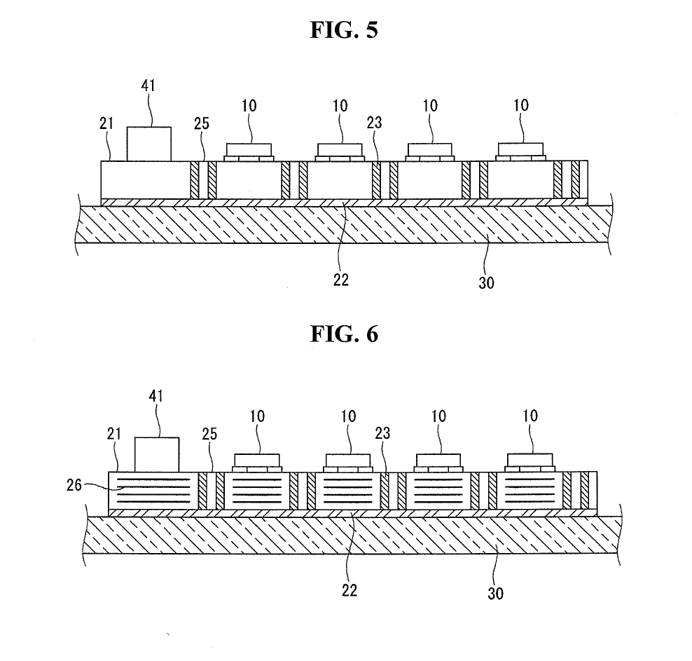

FIGS. 4 and 5 illustrate an apparatus for radiating heat of an LED according to a second embodiment of this disclosure.

Referring to FIGS. 4 and 5, a connector 41 and a plurality of LED packages 10 are mounted on the PCB 21 and circuit patterns for connecting the connector 41 and the LED packages 10 are formed thereon. A solder resist is coated on the PCB 21. A zener diode is formed in each LED packages 10, as illustrated in FIG. 1. A metal layer 22 is formed in a wide area on the bottom face of the PCB 21 and the solder resist is not formed thereon. The PCB 21 has a plurality of holes 2 penetrating the top and bottom faces of the PCB 21. The holes 25 are formed at portions of the PCB 21, on which the circuit patterns are not formed. The holes 25 are formed between the connector 41 and the LED package 10 adjacent to the connector 41 and between neighboring LED packages 10. Metal layers 23 are formed on the sidewalls of the holes 25 and cavities are respectively formed in the holes 25.

Heat of the LED packages 10 are radiated through the metal layers formed on the sidewalls of the holes 25, the metal layer 22 formed on the bottom face of the PCB 21 and the cover bottom 30. The metal layer 22 formed on the bottom face of the PCB 21 may come into contact with the bottom cover 30 to form a ground plane. The PCB 21 is bonded onto the cover bottom 30 through various methods as described above and there is no need to form an additional heat sink between the PCB 21 and the cover bottom 30.

The LED packages 10 may be replaced by LED chips directly formed on the PCB 21 through SMT process. Holes which penetrate the top and bottom faces of the PCB 21 and have metal layers formed on the sidewalls thereof may be respectively formed under the LED packages 10 or the LED chips, as illustrated in FIG. 1.

An FR4 PCB having more than four layers may be selected as the PCB 21 in order to improve LED heat-radiating effect and alleviate an increase in the size of the PCB 21 even when the number of LED packages 10 increases, as illustrated in FIG. 6. In case of the multi-layer PCB 21 having more than four layers, the holes 25 penetrating the top and bottom faces of the PCB 21 are formed at portions in which the circuit patterns and multi-layer circuit patterns are not formed. Metal layers 23 are formed on the sidewalls of the holes 25.

FIG. 7 is a cross-sectional view of a liquid crystal display according to a first embodiment of this disclosure.

Referring to FIG. 7, the liquid crystal display according to the first embodiment of this disclosure includes a liquid crystal display panel 61 and an edge type backlight unit for illuminating the liquid crystal display panel 61.

The edge type backlight unit includes the LED package 10 and the cover bottom 30 having the heat-radiating structure as described in the aforementioned embodiments. The edge type backlight unit further includes a light guide 63 located near to the LED package 10, a plurality of optical sheets 62 arranged between the light guide 63 and the liquid crystal display panel 61, a guide panel 64 supporting the liquid crystal display panel 61 and the edge type backlight unit, a case top 65 covering the side and top faces of the guide panel 64, and a reflecting sheet 66 arranged between the light guide 63 and the cover bottom 30. The LED package 10 faces an end of the light guide 63.

The liquid crystal display panel 61 includes a liquid crystal layer formed between upper and lower glass substrates. A plurality of data lines and a plurality of gate lines are formed in an intersecting manner on the lower glass substrate of the liquid crystal display panel 61. The liquid crystal display panel 61 includes liquid crystal cells respectively arranged at intersections of the data lines and the gate lines. The lower glass substrate of the liquid crystal display panel 61 includes the data lines, the gate lines, thin film transistors (TFTs), pixel electrodes of liquid crystal cells connected to the TFTs, and a storage capacitor, which are formed thereon. The upper glass substrate of the liquid crystal display panel 61 includes a black matrix and a color filter formed thereon. A common electrode is formed on the upper glass substrate in a vertical field driving mode such as a twisted nematic (TN) mode and a vertical alignment (VA) mode and formed on the lower glass substrate in a horizontal field driving mode such as an in-plane switching (IPS) mode and a fringe field switching (FFS) mode. Polarizers are respectively attached to the upper and lower glass substrates of the liquid crystal display panel 61 and alignment films for setting a pre-tilt angle of liquid crystal are respectively formed on the top and bottom faces of the liquid crystal layer.

The guide panel 64 is formed of a synthetic resin such as polycarbonate mixed with a glass fiber in the form of a rectangular frame and envelops the edges of the liquid crystal display panel 61 and the edge type backlight unit. A projected part is formed on the inner sidewall of the guide panel 64 and the liquid crystal display panel 61 is located on the projected part and the light guide 63 and the optical sheets 62 are arranged under the projected part. The optical sheets 62 include at least one prism sheet and at least one diffusion sheet, diffuse light received from the light guide 63 and refract a light traveling path at an angle substantially perpendicular to a light-receiving face of the liquid crystal display panel 61. The optical sheets 62 may include a dual brightness enhancement film (DBEF)

The LED package 10 is mounted on the PCB 21 having a hole. The PCB 21 is bonded onto the cover bottom 30. Heat of the LED package 10 is radiated through the metal layer formed on the sidewall of the hole of the PCB 21, the metal layer 22 formed on the bottom face of the PCB 21 and the bottom cover 30.

FIG. 8 is a cross-sectional view of a liquid crystal display according to a second embodiment of this disclosure.

Referring to FIG. 8, the liquid crystal display according to the second embodiment of this disclosure includes the liquid crystal display panel 61 and a direct type backlight unit for illuminating the liquid crystal display panel 61. The liquid crystal display panel 61 can be implemented in any mode such as the TN mode, VA mode, IPS mode and FFS mode.

The direct type backlight unit includes the LED packages 10 and the cover bottom 30 having the heat-radiating structure as described in the aforementioned embodiments. The direct type backlight unit further includes a diffuser 67 arranged on the LED packages 10, a plurality of optical sheets 62 arranged between the diffuser 67 and the liquid crystal display panel 61, a guide panel 69 supporting the liquid crystal display panel 61 and the direct type backlight unit, a cast top 68 covering the side and top face of the guide panel 69, and a reflecting sheet 70 attached to the cover bottom 30.

The LED packages 10 are mounted on the PCB 21 having holes. The PCB 21 is bonded onto the cover bottom 30. Heat of the LED packages 10 is radiated through the metal layers formed on the sidewalls of the holes of the PCB 21, the metal layer 22 formed on the bottom face of the PCB 21 and the bottom cover 30, as described in the above-described embodiments.

As described above, the invention can achieve an inexpensive LED heat-radiating structure by forming holes in the PCB and forming metal layers on the sidewalls of the holes, and thus the efficiency and lifetime of LEDs can be extended through sufficient heat radiation.

While this disclosure has been particularly shown and described with reference to exemplary embodiments thereof, it will be understood by those of ordinary skill in the art that various changes in form and details may be made therein without departing from the spirit and scope of this disclosure as defined by the following claims.

1. An apparatus for radiating heat of a light emitting diode (LED), comprising:
a plurality of LED packages respectively including a LED chip and a heat-radiating metal plate; and
a printed circuit board (PCB) including a top face with which the heat-radiating plate of the LED package is contacted and on which circuit patterns and solder resist are formed, a bottom face on which a metal layer is formed, a hole penetrating the top face and the bottom, a metal sidewall formed on the sidewall of the hole to connect the heat-radiating plate of the LED package with the metal layer, and a cavity formed in the hole.

2. The apparatus for radiating heat of a light emitting diode of claim 1, further comprising a metal substrate onto which the PCB is attached.

3. The apparatus for radiating heat of a light emitting diode of claim 1, wherein each of the LED packages comprises:
a package body having a top face on which the LED chip is mounted and a resin is coated and a bottom face on which the heat-radiating plate is formed;
a cathode lead frame formed of the same material as the heat-radiating metal plate at one side of the bottom of the package body and electrically connected to a cathode of the LED chip; and
an anode lead frame formed of the same material as the heat-radiating metal plate at the other side of the bottom face of the package body and electrically connected to an anode of the LED chip,
wherein the heat-radiating metal plate is disposed at the center of the package body to separate the cathode lead frame from the anode lead frame.

4. The apparatus for radiating heat of a light emitting diode of claim 1, wherein each of the LED packages further includes a zener diode connected to the LED chip.

5. The apparatus for radiating heat of a light emitting diode of claim 1, wherein the PCB further includes a plurality of second holes between neighboring LED packages and penetrating the top face and the bottom face of the PCB, second metal sidewalls on the sidewalls of the second holes, and second cavities respectively in the second holes.

6. A liquid crystal display comprising:
a liquid crystal display panel; and
a backlight unit that illuminates the liquid crystal display panel,
wherein the backlight unit comprises:
a plurality of LED packages respectively including a LED chip and a heat-radiating metal plate; and
a printed circuit board (PCB) including a top face with which the heat-radiating plate of the LED package is contacted and on which circuit patterns and solder resist are formed, a bottom face on which a metal layer is formed, a hole penetrating the top face and the bottom, a metal sidewall on the sidewall of the hole to connect the heat-radiating plate of the LED package and the metal layer, and a cavity in the hole.

7. The liquid crystal display of claim 6, further comprising a cover bottom onto which the PCB is attached.

8. The liquid crystal display of claim 6, wherein each of the LED packages comprises:
a package body having a top face on which the LED chip is mounted and a resin is coated and a bottom face on which the heat-radiating plate is formed;
a cathode lead frame formed of the same material as the heat-radiating metal plate at one side of the bottom of the package body and electrically connected to a cathode of the LED chip; and
an anode lead frame formed of the same material as the heat-radiating metal plate at the other side of the bottom face of the package body and electrically connected to an anode of the LED chip,
wherein the heat-radiating metal plate is formed at the center of the package body to separate the cathode lead frame from the anode lead frame.

9. The liquid crystal display of claim 6, wherein each of the LED packages further includes a zener diode connected to the LED chip.

10. The liquid crystal display of claim 6, wherein the PCB further includes a plurality of second holes between neighboring LED packages and penetrating the top face and the bottom face of the PCB, second metal sidewalls on the sidewalls of the second holes, and second cavities respectively in the second holes.
